(19) United States
(12) Patent Application Publication
(10) Pub. No.: US 2016/0006835 A1
(43) Pub. Date: Jan. 7, 2016

(54) Distributed Cloud Computing Platform

(71) Applicant: COMCAST CABLE COMMUNICATIONS, LLC, Philadelphia, PA (US)

(72) Inventors: Christopher Robinson, Monument, CO (US); David Zube, Centennial, CO (US)

(21) Appl. No.: 14/323,450

(22) Filed: Jul. 3, 2014

(51) Int. Cl. H04L 29/06; A63F 13/355; G06F 17/30; G06F 21/44; H04N 7/15; H04L 29/08

(52) U.S. Cl. CPC H04L 67/42; H04N 7/15; H04L 65/60; H04L 67/10; G06F 17/30598; G06F 21/445; A63F 13/355

(57) ABSTRACT

A distributed cloud computing platform can comprise a plurality of user devices and a plurality of servers connected by a network connection. The plurality of servers can be configured for collectively maintaining a communication session. A high bandwidth and low latency network connection between the plurality of servers can be configured for the transfer of communication session information between the plurality of servers. The plurality of user devices can be configured for participating in a communication session by interacting with the nearest of the plurality of servers.

### BACKGROUND

Cloud computing makes use of distributed computing resources available over a network. Computationally-intensive operations and processing tasks can be executed on one or more of the distributed computing resources at the request of a computing device that has access to the network. A drawback of cloud computing performance is latency, meaning the response delay between a user's request and the processing performed in response to the request. As an example, in a traditional multiplayer gaming session, user devices such as XBOX, are responsible for processing user commands. The user commands can be transmitted from one player to other players in the same match. The user devices associated with the other players can receive and process the user commands and update the gaming session accordingly. As a result, the user devices associated with corresponding players need to perform computationally-intensive operations. In addition, each user device can be connected to a different network, and the quality of service associated with the network can be different. These can lead to high latency in a cloud gaming environment. There is a need for more sophisticated methods and systems to improve latency in cloud computing platforms.

### SUMMARY

It is to be understood that both the following general description and the following detailed description are exemplary and explanatory only and are not restrictive, as claimed. Some of the disclosed are methods and systems related to distributed cloud computing platform sand generally to systems and methods for communication between computing devices.

An exemplary system can comprise a plurality of computing devices, such as servers, configured for collectively maintaining a communication session; a high bandwidth and low latency network connection between the plurality of computing devices that can be configured for transfer of communication session information between the plurality of computing devices (e.g., servers), and a plurality of user devices (e.g., clients) configured for participating in the communication session by interacting with a nearest one of the plurality of servers. In an aspect, the network connection between the plurality of servers can have higher bandwidth and lower latency than a connection between a client and one of the plurality of servers.

In another aspect, the present disclosure relates to methods for receiving a request to participate in a communication session from a first user device, directing the first user device to a data stream comprising information related to the communication session, receiving an interaction command from the first user device, and transmitting the interaction command to a plurality of computing devices (e.g., servers) over a network connection, wherein the plurality of computing devices (e.g., servers) may update the communication session according to the interaction command.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a block diagram of an exemplary system environment for distributed cloud computing;

FIG. 2 is a block diagram on an exemplary system in which the present methods and systems can operate;

FIG. 3 is a block diagram of an exemplary system in which the present methods and systems can operate;

FIG. 4 is a flowchart illustrating an example method for communication between network devices in the distributed cloud computing environment; and

FIG. 5 is a flowchart illustrating another example method for communication between network devices in the distributed cloud computing environment.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects.

Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Those skilled in the art will appreciate that present methods may be used in systems that employ both digital and analog equipment. One skilled in the art will appreciate that provided herein is a functional description and that the respective functions can be performed by software, hardware, or a combination of software and hardware.

The present disclosure relates to a distributed network system that can comprise a plurality of servers configured for collectively maintaining a communication session, a plurality of clients configured for participating in the communication session by interacting with a nearest one of the plurality of servers. In an aspect, the plurality of servers can be located in a plurality of disparate geographic regions. The plurality of servers can be connected through a high bandwidth and low latency network. As an example, the high bandwidth and low latency network can be configured to transmit communication session information at a speed higher than of 30 million bytes per second (Mpbs). As another example, the high bandwidth and low latency network can be configured to transmit communication session information at a latency of less than 25 milliseconds. In one aspect, a communication session can refer to any suitable program that requires one or more network devices to interact with a respective server in real time. For example, a communication session can be a video game, a video conference, a presentation, and the like.

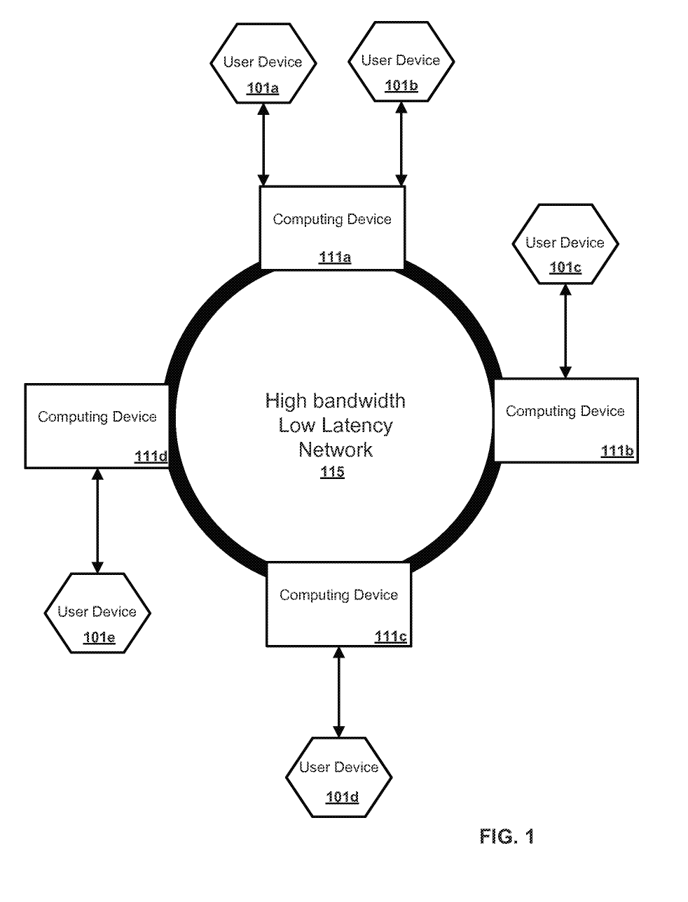

FIG. 1 illustrates a high-level block diagram of an example system environment for a distributed cloud computing platform. A plurality of user devices at different locations 101a,b,c,d,e can be configured to participate in a communication session hosted by one or more of a plurality of remote computing devices 111a,b,c,d. As an example, a user device can comprise a computer, a game console, a set top box, a smart TV, a tablet device, a smart phone, and the like. In an aspect, the communication session can comprise a video game session, a video conference session, a presentation, and the like. The communication session information can comprise voice, text, video, and the like. In an aspect, the remote computing device nearest to user devices 101a,b can be identified as 111a. The remote computing device nearest to user devices 101c can be identified as 111b. The remote computing device nearest to user devices 101d can be identified as 111c. The remote computing device nearest to user devices 101e can be identified as 111d. The plurality of the computing devices can be connected by network 115.

In one aspect, the network 115 or network connection between a user device and one of the plurality of remote computing devices can comprise a packet switched network (e.g., internet protocol based network), a non-packet switched network (e.g., quadrature amplitude modulation based network), and/or the like. The network 115 can comprise network adapters, switches, routers, and the like connected through wireless links (e.g., radio frequency, satellite) and/or physical links (e.g., fiber optic cable, coaxial cable, Ethernet cable). In an aspect, the network 115 can be configured for high bandwidth and low latency connection. For example, the network 115 can be configured to transmit communication session information at a speed higher than of 30 million bytes per second and at latency less than 25 milliseconds. In an aspect, the network 115 can have higher bandwidth and lower latency than the connection between a user device and one of the plurality of remote computing devices. Examples of the hardware implemented in the network 115 to establish high bandwidth and low latency connection can comprise Layer-3 switches and routers.

In an aspect, the network 115 can comprise a Hybrid Fiber Coaxial (HFC) network or any other bidirectional data communication medium that enables high bandwidth and low latency, low noise and low interference susceptibility connections. For example, one or more local area networks (LANs) or LAN segments can be used. Any type of physical medium in any configuration and any protocol, including wireless LAN technology and LANs that use the power lines, phone lines, existing cable television (CATV) coax, or custom installed wires, can be used.

As an example, the remote computing device 111a can receive a request to participate in a communication session from the user device 101a, the computing device 111a can, in turn, direct the user device 101a to a data stream comprising information related to the communication session. For example, a user can request to participate in a communication session by launching an application associated with the communication session on a user device (e.g., user device 101a) via an input interface, such as a remote control. As an example, the application can connect the user to a selection menu associated with a plurality of online games for an online gaming session. Once the user selects a game, the user device (e.g., user device 101a) can be tuned to a data stream comprising game data associated with the selected game intended for a specific user or user device. For example, the user device 101a can be tuned to the remote computing device 111a for a data stream associated with the selected game intended for the user device 101a. The user device 101b can be tuned to the remote computing device 111a for a data stream associated with the selected game intended for the user device 101b. The user device 101c can be tuned to the remote computing device 111b for a data stream associated with the selected game intended for the user device 101c, and so on.

In an aspect, the remote computing device 111a can receive an interaction command from the user device 101a and transmit the interaction command to the plurality of remote computing devices 111b,c,d over the network 115. In an aspect, the plurality of remote computing devices can update the communication session according to the interaction command. For example, in a gaming session, the data stream can comprise a current round of gaming data relevant to a specific user or user device. Specifically, the remote computing device 111a can direct the current round of gaming data relevant to user device 101a to user device 101a, and direct the current round of gaming data relevant to user device 101b to user device 101b. Similarly, the remote computing device 111b can direct the current round of gaming data relevant to user device 101c to user device 101c. The remote computing device 111c can direct the current round of gaming data relevant to user device 101d to user device 101d. The remote computing device 111d can direct the current round of gaming data relevant to user device 101e to user device 101e.

In an aspect, the remote computing devices 111a,b,c,d can be located in one or more geographic regions. As an example, remote computing device 111a can comprise a headend for the user devices 101a and 101b. The remote computing device 111b can comprise a headend for the user devices 101c. The remote computing device 111e can comprise a headend for the user device 101d. The remote computing device 111d can comprise a headend for the user device 101e.

In an aspect, the computing device at a user device's headend can be used to host the communication session and interact with the respective user device. For example, the remote computing device 111a can be used to host the communication session for user devices 101a and 101b. The remote computing device 111b can be used to host the communication session for the user device 101c. The remote computing device 111 can be used to host the communication session for the user device 101d, and the remote computing device 111d can be used to host communication session for the user device 101e. Thus, each participant user device can be connected to the remote computing device nearest to the user device.

In an aspect, the disclosed cloud computing platform can utilize remote computing devices located at or near network end-points. In another aspect, synchronized internal clocks can be implemented on user devices 101a,b,c,d,e and/or computing devices 111a,b,c,d to enable the user devices and/or computing devices to perform on a unified timeline. As a result, user devices participating in a communication session can have similar latency, which can offer a level of connection standardization. When the user devices participating in the communication session have similar latency, the game experience can be smoother and more responsive for the participating players. In an aspect, utilizing a remote computing device at or near a user device's headend can enable the shortest route (e.g., fiber route) and minimize interconnect requirements (e.g., shortest patch cords, collocate equipment) to minimize latency.

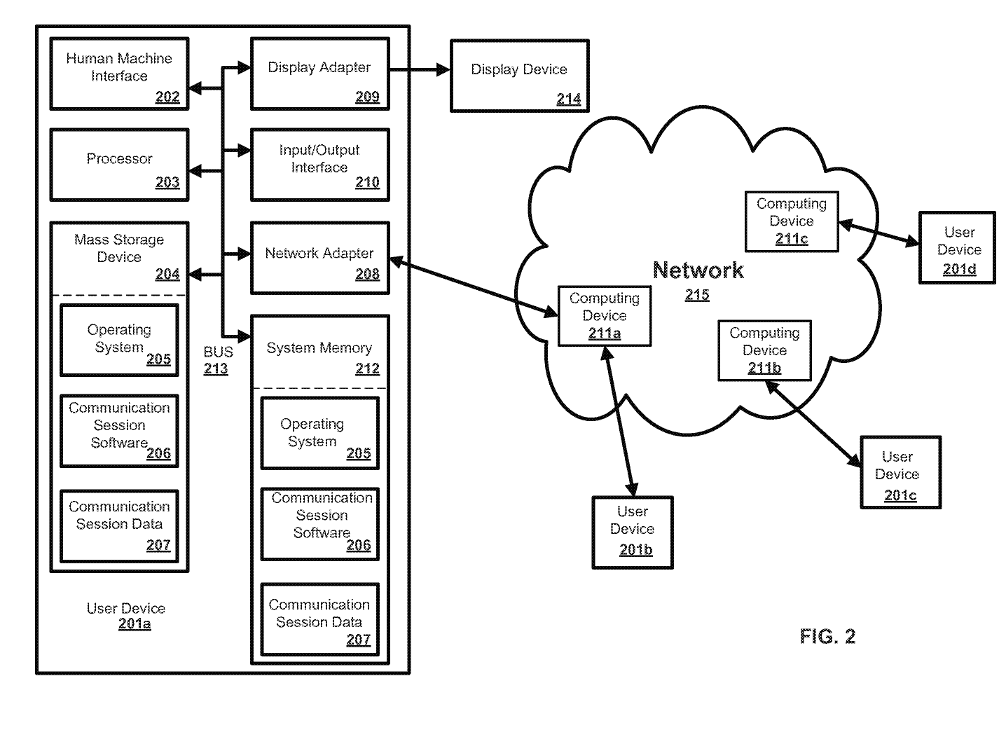

FIG. 2 is a block diagram of an exemplary system in which the present methods and systems can operate. In an aspect, the methods and systems can be implemented on user device 201a as illustrated in FIG. 2 and described below. By way of example, the user devices 101a,b,c,d,e of FIG. 1 can be the user devices 201a, 201b, 201c, 201d as illustrated in FIG. 2 The remote computing devices 111a,b,c,d of FIG. 1 can be the remote computing devices 211a, 211b or 211c as illustrated in FIG. 2. The methods and systems disclosed can utilize one or more computers to perform one or more functions in one or more locations. FIG. 2 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a user device 201a. The components of the user device 201a can comprise, but are not limited to, one or more processors or processing units 203, a system memory 212, and a system bus 213 that couples various system components, including the processor 203, to the system memory 212. In the case of multiple processing units 203, the system can utilize parallel computing.

The system bus 213 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 213, and all buses specified in this description can also be implemented over a wired or wireless network connection and each of the subsystems, including the processor 203, a mass storage device 204, an operating system 205, communication session software 206 (e.g., gaming software), communication session data 207 (e.g., gaming data), a network adapter 208, system memory 212, an Input/Output Interface 210, a display adapter 209, a display device 214, and a human machine interface 202, can be contained within one or more remote computing devices 211a, 211b, 211c at physically separate locations, connected through buses of this form, in effect implementing a fully distributed system.

The user device 201a typically comprises a variety of computer readable media. Exemplary readable media can be any available media that is accessible by the user device 201a and comprises, for example and not meant to be limiting, both volatile and non-volatile media, removable and non-removable media. The system memory 212 comprises computer readable media in the form of volatile memory, such as random access memory (RAM), and/or non-volatile memory, such as read only memory (ROM). The system memory 212 typically contains data, such as communication session data 207, and/or program modules, such as operating system 205 and communication session software 206, that are immediately accessible to and/or are presently operated on by the processing unit 203.

In another aspect, the user device 201a can also comprise other removable/non-removable, volatile/non-volatile computer storage media. By way of example, FIG. 2 illustrates a mass storage device 204 which can provide non-volatile storage of computer code, computer readable instructions, data structures, program modules, and other data for the user device 201a. For example and not meant to be limiting, a mass storage device 204 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 204, including by way of example, an operating system 205 and communication session software 206. Each of the operating system 205 and communication session software 206 (or some combination thereof) can comprise elements of the programming and the communication session software 206. Communication session data 207 can also be stored on the mass storage device 204. Communication session program data 207 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the user device 201a via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 203 via a human machine interface 202 that is coupled to the system bus 213, but can be connected by other interface and bus structures, such as a parallel port, game port, an IEEE 1394 Port (also known as a Firewire port), a serial port, or a universal serial bus (USB).

In yet another aspect, a display device 214 can also be connected to the system bus 213 via an interface, such as a display adapter 209. It is contemplated that the user device 201a can have more than one display adapter 209 and the user device 201a can have more than one display device 214. For example, a display device can be a monitor, an LCD (Liquid Crystal Display), or a projector. In addition to the display device 214, other output peripheral devices can comprise components such as speakers (not shown) and a printer (not shown) which can be connected to the user device 201a via Input/Output Interface 210. Any step and/or result of the methods can be output in any form to an output device. Such output can be any form of visual representation, including, but not limited to, textual, graphical, animation, audio, tactile, and the like. The display 214 and user device 201a can be part of one device, or separate devices.

The user device 201a can operate in a networked environment using logical connections to one or more user devices 201b, 201c, 201d. By way of example, a user device can comprise a personal computer, a portable computer, a tablet, a smart phone, a game console, and the like. Logical connections between the user devices 201a, 201b, 201c, 201d can be made via interacting with one of a plurality of remote computing device 211a, 211b, 211c. By way of example, a remote computing device can comprise a server, a network computer, a peer device or other common network node, and the like. The connection between a user device and a remote computing device can be through a network adapter 208. A network adapter 208 can be implemented in both wired and wireless environments. Such networking environments are conventional and commonplace in dwellings, offices, enterprise-wide computer networks, intranets, and the Internet.

In an aspect, the plurality of remote computing devices 211a, 211b, 211c can be connected via the network 215. The network connection can be configured for high bandwidth and low latency between the plurality of remote computing devices 211a, 211b, 211c. For example, the network 215 can be configured to transmit communication session information at a speed higher than of 30 million bytes per second (Mpbs) and latency less than 25 milliseconds. The network 215 can refer to any suitable telecommunications network including one or more of the following: a television network, the Internet, local intranet, PAN (Personal Area Network), LAN (Local Area Network), WAN (Wide Area Network), MAN (Metropolitan Area Network), virtual private network (VPN), storage area network (SAN), frame relay connection, Advanced Intelligent Network (AIN) connection, synchronous optical network (SONET) connection, digital T1, T3, E1 or E3 line, Digital Data Service (DDS) connection, DSL (Digital Subscriber Line) connection, Ethernet connection, ISDN (Integrated Services Digital Network) line, cable modem, ATM (Asynchronous Transfer Mode) connection, an FDDI (Fiber Distributed Data Interface) or CDDI (Copper Distributed Data Interface) connection, and so forth.

For purposes of illustration, application programs and other executable program components, such as the operating system 205, are illustrated herein as discrete blocks, although it is recognized that such programs and components reside at various times in different storage components of the user device 201a and are executed by the data processor(s) of the computer. An implementation of communication session software 206 can be stored on or transmitted across some form of computer readable media. Any of the disclosed methods can be performed by computer readable instructions embodied on computer readable media.

Computer readable media can be any available media that can be accessed by a computer. By way of example and not meant to be limiting, computer readable media can comprise “computer storage media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ artificial intelligence (AI) techniques, such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

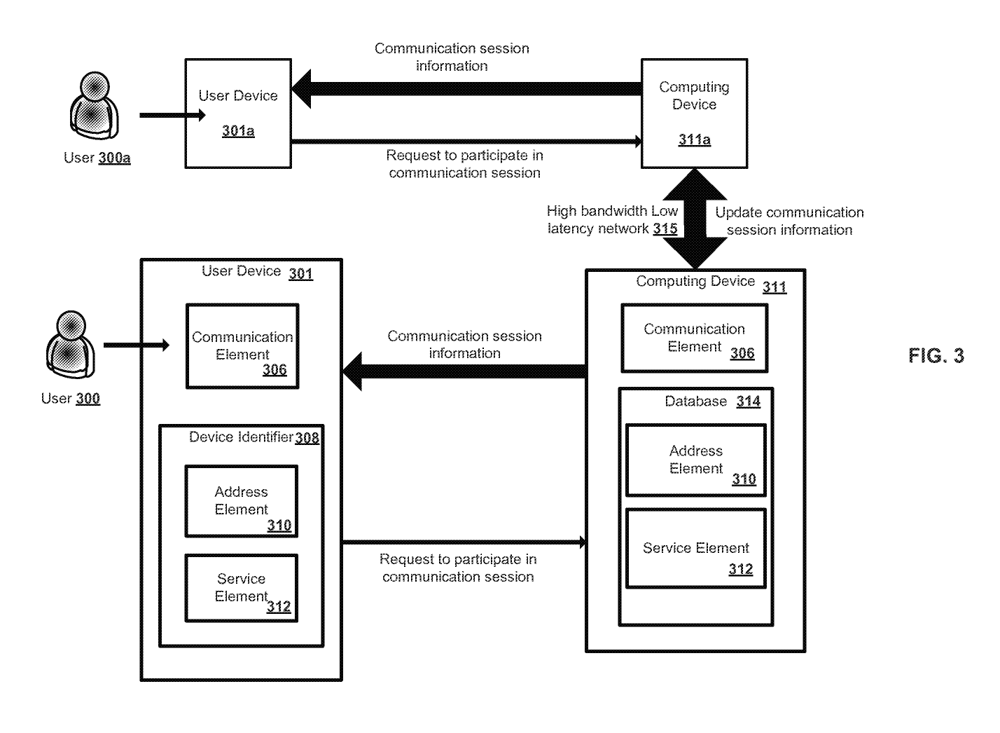

FIG. 3 is a block diagram of an exemplary system in which the present methods and systems can operate. In an aspect, the methods and systems can be implemented on user devices 301, 301a and remote computing devices 311, 311a, as illustrated in FIG. 3. In one aspect of the disclosure, a system can be configured for the computing device 311 to provide services to the user device 301, and the remote computing device 311a to provide services to the user device 301a. As an example, a user device can comprise a computer, a tablet, a mobile device, a game console, a set-top box, and the like. As another example, a remote computing device can comprise a server, a network computer, a communication terminal, a peer device, other common network node, and the like.

In an aspect, the user device 301 can be in communication with the remote computing device 311. The remote computing device 311 can be disposed remotely relative to the user device 301. As an example, the remote computing device 311 can be located at or near the headend of the user device 301. In an aspect, the user device 301 and the remote computing device 311 can be in communication via a private and/or public network 305, such as the Internet or a local area network. Other forms of communications can be used, such as wired and wireless telecommunication channels.

In an aspect, the user device can comprise a communication element 306 for providing an interface to a user to interact with the user device 301 and/or the remote computing device 311. The communication element 306 can be any interface for presenting and/or receiving information to/from the user, such as user feedback.

An example interface may be communication interface, such as a web browser, program guide, or the like. In another aspect, the communication element 306 can request, query or transmit various files related to a communication session from a remote source such as the remote computing device 311. As an example, user devices 301 and 301a can be game consoles. The communication element 306 can be a game client. The remote computing devices 311 and 311a can be servers configured for providing one or more gaming services. A gaming service can comprise a single and/or multiplayer video game. Specifically, the remote computing device 311 can provide a gaming service to the user device 301. The remote computing device 311a can provide a gaming service to the user device 301a. In an aspect, a user 300 can request to participate in a video game through an input interface of the communication element 306 in the user device 301. As an example, the input interface can comprise a button, a joystick, a keyboard, a pointing device (e.g., “mouse”), a microphone, a remote control, and the like. For example, a user 300 can request to participate in a communication session by launching an application associated with the communication session on his user device 301 via an input interface, such as a remote control. Specifically, for an online gaming session, the application can connect the user 300 to a selection menu associated with a plurality of online games. Once the user 300 selects a game, his user device 301 can be tuned to a data stream comprising game data associated with the selected game intended for the user 300 or user device 301. Specifically, the remote computing device 311 can direct to the user device 301 a data stream comprising information related to the video game (e.g., video and audio content stream related to the requested game) intended for the user 300. The user 300 can provide an interaction command to the remote computing device 311 through the input interface. As an example, the interaction command can comprise moving game characters or avatars; actions that impact other game characters, avatars, and/or game environments (e.g., shooting a weapon at an avatar); or other interaction command suitable to the game.

The remote computing device 311 can receive the interaction command from the user device 301 and transmit the interaction command to the remote computing device 311a via a high band width and low latency network 315, wherein the remote computing device 311a can update the game session according to the interaction command. The updated game session can be transmitted from the remote computing device 311a to the user device 301a. In an aspect, a user 300a can provide an interaction command through the communication element (not shown) of the user device 301a after receiving the updated gaming session. In an aspect, communication session information can be displayed on the user device. For example, movement of game characters or avatars can be displayed on the user devices 301 and 301a. In an aspect, the game servers (e.g., computing device 311, computing device 311a) can manage network connections, matchmaking, and retain persistent data (e.g., earned medals, achieved levels, etc.) associated with players (e.g., user 300, user 300a) in a multiplayer gaming environment.

In an aspect the remote computing device (e.g., computing device 311) can allocate sufficient GPU capacity to render graphics associated with the gaming session at one of a plurality of resolutions to display on the user device (e.g., user device 301). In an aspect, the computing device can determine the resolution for rendering graphics based on the number of requests (e.g., interaction commands) the GPU is processing at the time and the processing power of the GPU. In another aspect, the user (e.g., user 300) or user device (e.g., user device 301) can have the option of selecting a graphic display resolution from a plurality of optional resolutions.

In an aspect, the user device 301 can be associated with a user identifier or device identifier 308. As an example, the device identifier 308 can be any identifier, token, character, string, or the like, for differentiating one user or user device (e.g., user device 301) from another user or user device. In a further aspect, the device identifier 308 can identify a user or user device as belonging to a particular class of users or user devices. As a further example, the device identifier 308 can comprise information relating to the user device, such as a manufacturer, a model or type of device, a service provider associated with the user device 301, a state of the user device 301, a locator, and/or a label or classifier. Other information can be represented by the device identifier 308. In an aspect, the device identifier 308 can be used to locate a nearest remote computing device. As such, a request to participate in the communication session from user 300 can be transmitted to the nearest remote computing device (e.g., the remote computing device 311) among a plurality of the remote computing devices. In another aspect, the device identifier 308 can be received by a remote computing device as part of the request to participate in the communication session, so that the communication session information can be updated and displayed on all user devices in the communication session according to respective device identifier 308.

In an aspect, the device identifier 308 can comprise an address element 310 and a service element 312. In an aspect, the address element 310 can comprise or provide an internet protocol address, a network address, a media access control (MAC) address, an Internet address, or the like. As an example, the address element 310 can be relied on to establish a communication session between the user device 301 and the remote computing device 311 or other devices and/or networks. As a further example, the address element 310 can be used as an identifier or locator of the user device 301. In an aspect, the address element 310 can be persistent for a particular network. In an aspect, the address element 310 can be used to locate the nearest remote computing device. As such, a request to participate in the communication session from user 300 can be transmitted to the nearest remote computing device (e.g., remote computing device 311). In another aspect, the address element 310 can be received by a remote computing device as part of the request to participate in the communication session, so that the communication session information can be updated and displayed on all user devices in the communication session according to the respective address element 310. In another aspect, address element 310 can be used for the remote computing devices to transmit the communication session information to the user devices at their respective locations.

In an aspect, the service element 312 can comprise an identification of a service provider associated with the user device 301 and/or with the class of user device 301. The class of the user device 301 can be related to a type of device, capability of device, type of service being provided, and/or a level of service (e.g., business class, service tier, service package, etc.). As an example, the service element 312 can comprise information relating to or provided by a communication service provider (e.g., Internet service provider) that is providing or enabling data flow such as communication services to the user device 301. As a further example, the service element 312 can comprise information relating to a preferred service provider for one or more particular services relating to the user device 301. In an aspect, the address element 310 can be used to identify or retrieve data from the service element 312, or vise versa. As a further example, one or more of the address element 310 and the service element 312 can be stored remotely from the user device 301 and retrieved by one or more devices, such as the user device 301 and the remote computing device 311. Other information can be represented by the service element 312. In an aspect, the service element 312 can process a request for participating in the communication session from a user device. For example, the service element 312 can identify the requested communication session (e.g., gaming) and prioritize communication session information. Specifically, high priority communication session information can be transmitted prior to transmitting low priority communication session information. In an aspect, high priority communication session information can comprise real-time communication session information. For example, high priority communication session information can comprise moving a game character or avatar, or opening fire with an in-game weapon, whereas low priority communication session information can comprise changing the background pattern of a gaming program, or changing the display color of a gaming character, or other aspects of a video game which are less time sensitive.

In an aspect, the remote computing device 311 can be a server for communicating with the user device 301. As an example, the remote computing device 311 can communicate with the user device 301 for providing data and/or services. As an example, the server 311 can provide services such as network (e.g., Internet) connectivity, media management (e.g., media server), content services (e.g., video gaming), streaming services, broadband services, or other network-related services. In an aspect, the computing device 311 can be configured to interact with other remote resources, such as data, devices, and files. For example, the computing device 311 can be configured to communicating with a Pay-Per-View (PPV) server or a video-on-demand (VOD) server. Specifically, a remote computing device 311 can direct a request to participate in a communication session from user 300 to a PPV or VOD server. The PPV or VOD server can authenticate the entitlement of the user 300 to access the requested information before requested communication session information can be transmitted from the remote computing device 311 to the user device 301. In another aspect, the remote computing device 311 can be connected with an encoder (e.g., MPEG encoder). As such, communication session information can be encoded before being transmitted to the user device 301. A decoder can be used to decode communication session information before it can be displayed on the user device 301. In an aspect, the encoder and decoder can enable more efficient usage of the communication bandwidth between the user device 301 and the remote communication device 311.

In an aspect, the remote computing device 311 can manage the communication between the user device 301 and a database 314 for sending and receiving data therebetween. As an example, the database 314 can store a plurality of files (e.g., game data files), user identifiers or records, or other information. As a further example, the user device 301 can request and/or retrieve a file from the database 314. In an aspect, the database 314 can store information relating to the user device 301 such as the address element 310 and/or the service element 312. As an example, the remote computing device 311 can obtain the device identifier 308 from the user device 301 and retrieve information from the database 314, such as the address element 310 and/or the service elements 312. As a further example, the remote computing device 311 can obtain the address element 310 from the user device 301 and can retrieve the service element 312 from the database 314, or vice versa. Any information can be stored in and retrieved from the database 314. The database 314 can be disposed remotely from the remote computing device 311 and accessed via direct or indirect connection. The database 314 can be integrated with the remote computing device 311 or some other device or system. In an aspect, the database 314 can be configured to store information associated with the communication session program. As an example, the stored information can comprise a communication session application, user profile information (e.g., device identifier 308 of a user device, address element 310 of a user device, previous communication session information associated with a user), or some other information associated with a communication session or a user device. In an aspect, the database 314 can be configured to store frequently retrieved data associated with a communication session in its high-speed memory, which can permit a remote computing device to process requests for the communication session more quickly.

As a specific example, a user 300 can press a button on a user device 301 (e.g., game console) to transmit a request to participate in a game session to a computing device 311 (e.g., game server) located at the headend of the user device 301, for example, the nearest headend to the user device 301. The user device 301 can be tuned to a data stream comprising game data associated with the request. A menu of available games can be displayed on a display device (e.g., TV) associated with the user device 301. The user 300 can select a specific game from the menu, and a communication session can be established between the user device 301 and the computing device 311. The user device 301 can transmit one or more interaction commands to the computing device 311 as the user 300 plays the selected game. In an aspect, the computing device 311 can prioritize communication session information associated with one or more interaction commands. Specifically, high priority communication session information can be transmitted prior to transmitting low priority communication session information. For example, high priority communication session information can comprise moving a game character or avatar, or opening fire; whereas low priority communication session information can comprise changing the background pattern of a gaming program, or changing the display color of a gaming character, which are less time sensitive. In an aspect, the computing device 311 can render a communication session video according to the interaction command received from user 300. As an example, the video can comprise Just-In-Time-Packaged video, MPEG 4 video, HD video, video generated on the fly, and the like. As a result, a player (e.g., user 300) can access a game server close to the player (e.g., computing device 311). In an aspect, the video can be delivered through a video channel (e.g., television channel). For example, there can be a designated channel (e.g., QAM channel, IP channel) to deliver the rendered video. The designated channel can be assigned a higher bandwidth and/or higher data transmission rate. In an aspect, the computing device 311 can transmit the rendered video in Apple HTTP Live Streaming, Microsoft Smooth Streaming, Adobe HTTP Dynamic Streaming, MPEG Dynamic Adaptive Streaming over HTTP (DASH), Real Time Messaging Protocol (RTMP) formats, and other formats. In another aspect, the computing device 311 can also deliver just-in time output for TV, video-on-demand (VOD), and other network video delivery and/or streaming services.

The game server (e.g., computing device 311) can communicate with another game server (e.g., game server 311a) via high bandwidth links. For example, the computing device 311 can transmit the rendered video to the computing device 311a. In an aspect, the inter server communication via the high bandwidth links can also be prioritized. For example, an active multiplayer gaming session can be made a higher priority than other traffic. As another example, image information for a gaming session, for example, can be prioritized over voice information for the gaming session, because voice latency can be less apparent to end users. Therefore, latency can be reduced by keeping each of the communication sessions as physically and logically close as possible.

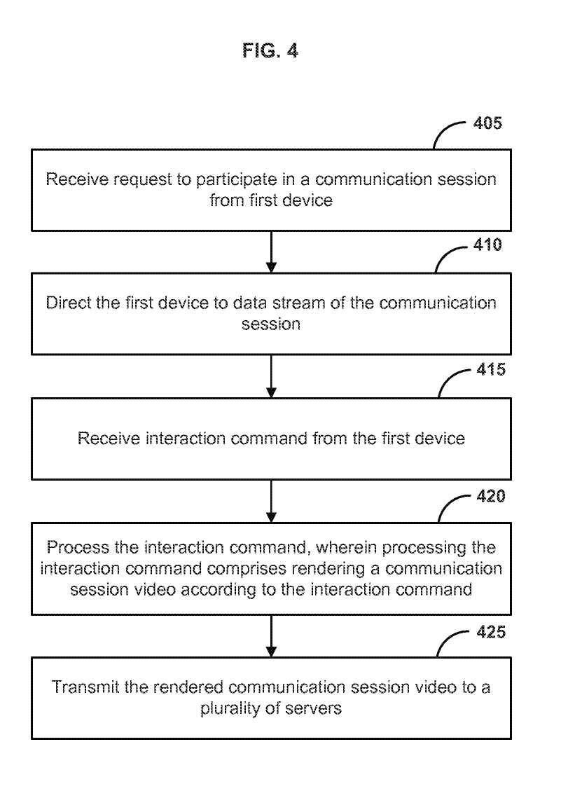

FIG. 4 is a flowchart illustrating an example method. At step 405, a remote computing device can receive a request to participate in a communication session from a first user device. By way of example, a remote computing device can comprise a server, a network computer, a peer device or other common network node, and the like. In an aspect, a plurality of remote computing devices can host the communication session. In an aspect, the remote computing device nearest to the first user device can receive the request. As an example, the remote computing device nearest to the first user device can be located at the headend of the first user device. In an aspect, the request can be made by the user of the first device via a communication element (e.g., an input interface) of the first user device. As an example, the input interface can comprise a button, a joystick, a keyboard, a pointing device (e.g., “mouse”), a microphone, a remote control, and the like. For example, a user (e.g., user 300) can request to participate in a communication session by launching an application associated with the communication session on his user device (e.g., user device 301) via an input interface, such as a remote control. Specifically, for an online gaming session, the application can connect the user (e.g., user 300) to a selection menu associated with a plurality of online games, and the user (e.g., user 300) can make a selection. In an aspect, the remote computing device can process the request for participating in the communication session. As an example, the remote computing device can determine that a user is requesting a communication session (e.g., an online game) by reading one or more cookies appended to hypertext transfer protocol (HTTP) requests transmitted by the user's device, and/or by a user logging onto a communication session application. In an aspect, a first user device can comprise a computer, a game console, a set top box, a smart TV, a tablet, a smart phone, and the like.

At step 410, the remote computing device can direct the first user device to a data stream comprising information related to the communication session. By way of example, a remote computing device can comprise a server, a network computer, a peer device or other common network node, and the like. In an aspect, the remote computing device nearest to the first user's device can execute the requested communication session. As an example, for an online gaming session, once the user 300 selects a game on his user device 301, the user device 301 can be tuned to a data stream comprising game data associated with the selected game intended for the user 300 or user device 301. Specifically, the remote computing device 311 can retrieve program data associated with the requested communication session from its database and direct the data to the first user device according to the device identifier of the first user device. As an example, the communication session can comprise a video game, a video conference, a presentation and the like. In an aspect, the communication session information can be encoded (e.g., MPEG encoded) before being delivered to the first user device. As such, a decoder (e.g., MPEG decoder) can be used to decode the communication session information. The decoder can be implemented in or coupled to the first user device.

At step 415, the remote computing device can receive an interaction command from the first user device. In an aspect, the remote computing device can prioritize communication session information in the interaction command. Specifically, high priority communication session information can be transmitted prior to transmitting low priority communication session information. In an aspect, high priority communication session information can comprise real-time communication session information. For example, high priority communication session information can comprise interaction commands, such as moving a game character or avatar, or opening fire; whereas low priority communication session information can comprise interaction commands, such as changing the background pattern of a gaming program, or changing the display color of a gaming character, which are less time sensitive.

At step 420, the interaction command can be processed. As another example, in a gaming session, upon receiving the interaction command, the remote computing device (e.g., game server) can determine the game character states, game state, the outcome of game events, and/or the like. As a further example, the parameters related to the game character, such as location, speed, orientation and interaction forces between the game characters, can be calculated.

In an aspect, processing the interaction command can comprise rendering a communication session video according to the interaction command. As an example, the video can comprise Just-In-Time-Packaged video, MPEG 4 video, HD video, video generated on the fly, and the like. In an aspect, the remote computing device can allocate sufficient GPU capacity to render graphics associated with the communication session (e.g., gaming session) at one of a plurality of resolutions to display on user devices. In an aspect, the computing device can determine the resolution for rendering graphics based on the number of requests (e.g., interaction commands) the GPU is processing at the time and the processing power of the GPU. In another aspect, a user or user device can have the option of selecting a display resolution (e.g., graphical avatars resolution) from a plurality of optional resolutions.

In another aspect, processing the interaction command can comprise determining the priority of the interaction command. A higher priority interaction command can be processed prior to a lower priority interaction command. For example, interaction command involving image processing for a gaming session can be prioritized over interaction command involving voice processing for the gaming session, because voice latency can be less apparent to end users. In an aspect, real-time information can be transmitted with higher priority. Real-time information can be transmitted prior to transmitting non-real-time information. As an example, high priority interaction command can comprise moving a game character or avatar, or opening fire; whereas low priority interaction command can comprise changing the background pattern of a gaming program or changing the display color of a gaming character which are less time sensitive. As such, in a gaming session, calculating the parameters such as location, speed, orientation, state (e.g., earned medals, achieved levels), and interaction forces between the game characters, can be processed with a higher priority.

At step 425, the remote computing device can transmit the rendered communication session video to a plurality of remote computing devices in a network serving other participant user devices in the communication session. In an aspect, the rendered communication session video can be transmitted with a higher priority than other network traffic. In an aspect, the plurality of remote computing devices can update the communication session according to the interaction command. In an aspect, the network connection between the plurality of remote computing devices can be configured for high bandwidth and low latency connection. As an example, the network connection can be configured to transmit communication session information at a speed higher than of 30 million bytes per second (Mpbs) and latency less than 25 milliseconds. The plurality of remote computing devices can update the communication session according to the interaction command.

In an aspect, in a gaming session, a plurality of remote computing devices (e.g., game servers) can update and/or synchronize the game state and game character state based on the game logic and input from participant user devices. In another aspect, after the plurality of remote computing devices update the communication session according to the interaction command, the plurality of remote computing devices can transmit the rendered communication session video and other communication session information to the respective participant user devices. As an example, in an online gaming session, game characters can be updated and displayed as graphical avatars on user devices.

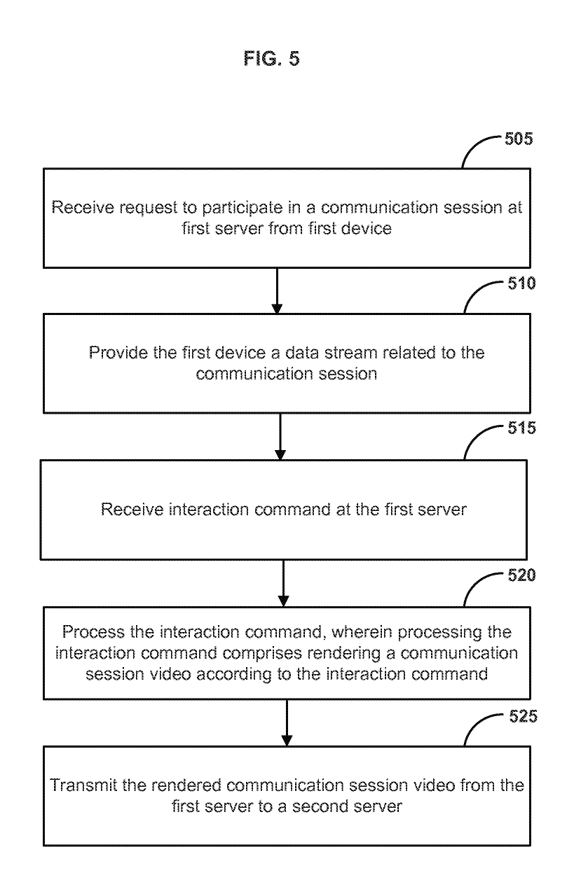

FIG. 5 is a flowchart illustrating another example method for implementing the disclosed method. At step 505, a first remote computing device can receive a request to participate in a communication session. By way of example, a first remote computing device can comprise a server, a network computer, a peer device or other common network node, and the like. In an aspect, the request can be made by a user of a user device making an input on a communication element (e.g., input interface) of the user device. As an example, the input interface can comprise a button, a joystick, a keyboard, a pointing device (e.g., “mouse”), a microphone, a remote control, and the like. In an aspect, the remote computing device can process the request for participating in the communication session. As an example, the remote computing device can determine that a user is requesting a communication session (e.g., an online game) by reading one or more cookies appended to hypertext transfer protocol (HTTP) requests transmitted by the user device, and/or by the user logging onto a communication session application. In an aspect, the first computing device can be the nearest computing device to the user device requesting the communication session. As an example, the first computing device can be located at a headend of the user device.

In an aspect, a plurality of remote computing devices can host the requested communication session. In an aspect, the remote computing device nearest to the first user device can receive the request. As an example, the server nearest to the first user device can be located at the headend of the first user device.

At step 510, a first user device can be provided a data stream comprising information related to the communication session from the first computing device. As an example, the first user device can comprise a computer, a game console, a set top box, a smart TV, a tablet, a smart phone, and the like. As an example, the first remote computing device can retrieve program data associated with the requested communication session from its database and direct the data to the first user device according to the device identifier of the first user device. As an example, the communication session can comprise a video game, a video conference, a presentation and the like. In an aspect, the communication session information can be encoded (e.g., MPEG encoded) before being delivered to the first user device. As such, a decoder (e.g., MPEG decoder) can be used to decode the communication session information. The decoder can be implemented in or coupled to the first user device.

At step 515, the first remote computing device can receive an interaction command from the first user device. In an aspect, the first remote computing device can prioritize communication session information in the interaction command. Specifically, high priority communication session information can be transmitted prior to transmitting low priority communication session information. In an aspect, high priority communication session information can comprise real-time communication session information and low priority communication session information can comprise non real-time communication session information. For example, real-time communication session information can comprise interaction commands (e.g., which are more time sensitive, relative to other interaction commands), such as moving a game character or avatar, or opening fire; whereas non real-time communication session information can comprise other interaction commands (e.g., which are less time sensitive), such as changing the background pattern of a gaming program or changing the display color of a gaming character.

At step 520, the interaction command can be processed. As another example, in a gaming session, upon receiving the interaction command, the remote computing device (e.g., game server) can determine the game character states, game state, outcome of the game events, and/or the like. As a further example, the parameters related to the game character, such as location, speed, orientation and interaction forces between the game characters, can be calculated.

In an aspect, processing the interaction command can comprises rendering a communication session video according to the interaction command. As an example, the video can comprise Just-In-Time-Packaged video, MPEG 4 video, HD video, video generated on the fly, and the like. In an aspect, the remote computing device can allocate sufficient GPU capacity to render graphics associated with the communication session (e.g., gaming session) at one of a plurality of resolutions to display on the user devices. In an aspect, the computing device can determine the resolution for rendering graphics based on the number of requests (e.g., interaction commands) the GPU is processing at the time and the processing power of the GPU. In another aspect, a user or user device can have the option of selecting a display resolution (e.g., graphical avatars resolution) from a plurality of optional resolutions.

In another aspect, processing the interaction command can comprise determining the priority of the interaction command. A higher priority interaction command can be processed prior to a lower priority interaction command. For example, interaction command involving image processing for a gaming session can be prioritized over interaction command involving voice processing for the gaming session, because voice latency can be less apparent to end users. In an aspect, real-time information can be transmitted with higher priority. Real-time information can be transmitted prior to transmitting non-real-time information. As an example, high priority interaction command can comprise moving a game character or avatar, or opening fire; whereas low priority interaction command can comprise changing the background pattern of a gaming program or changing the display color of a gaming character which are less time sensitive. As such, in a gaming session, calculating the parameters such as location, speed, orientation, state (e.g., earned medals, achieved levels), and interaction forces between the game characters, can be processed with a higher priority.

At step 525, the first remote computing device can transmit the rendered communication session video to a second remote computing device. In an aspect, the rendered communication session video can be transmitted with a higher priority than other network traffic. In an aspect, the first and second remote computing devices can update the communication session according to the interaction command. In an aspect, the network connection between the first and second remote computing devices can be configured for high bandwidth and low latency connection. As an example, the network connection can be configured to transmit communication session information at a speed higher than of 30 million bytes per second (Mpbs) and latency less than 25 milliseconds.

In an aspect, the first and second remote computing devices can update the communication session according to the interaction command. In an aspect, in a gaming session, the first and second remote computing devices (e.g., game servers) can update and/or synchronize the game state and game character state based on the game logic and input from participant user devices. In another aspect, the network connection between the first and the second remote computing devices can be configured to transmit the interaction command with a higher priority/more bandwidth than other network traffic between the two remote computing devices. For example, the first and the second remote computing devices can enable the communication session information to be high priority data files. As such, the interaction command related to the communication session can be transmitted first, while lower priority data files or users can be put on hold.

The second remote computing device can transmit the rendered communication session video and other communication session information to a second user device. As an example, in an online gaming session, videos of updated game characters can be transmitted and displayed as graphical avatars on the first user device and second user device. As such, latency can be reduced by keeping each of the communication sessions as physically and logically close as possible.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A system comprising:
a plurality of servers configured for collectively maintaining a communication session, wherein the plurality of servers are configured to process communication session information;
a network connection between the plurality of servers wherein the network connection is configured to transfer the communication session information between the plurality of servers, wherein the network connection is configured for high bandwidth and low latency between the plurality of servers; and
a plurality of user devices configured for participating in the communication session by interacting with a nearest one of the plurality of servers.

2. The system of claim 1, wherein the communication session is a video game, a video conference, or a presentation.

3. The system of claim 1, wherein processing communication session information comprises rendering a communication session video according to communication session information, and transmitting the rendered communication session video to one or more of the plurality of user devices.

4. The system of claim 1, wherein the communication session information is prioritized, wherein the plurality of servers are configured to process high priority communication session information prior to low priority communication session information.

5. The system of claim 1, wherein the communication session information is prioritized, wherein the network is configured to transmit high priority communication session information prior to low priority communication session information.

6. The system of claim 5, wherein the high priority communication session information comprises real-time communication session information.

7. The system of claim 6, wherein the high priority communication session information comprises real-time video game information.

8. The system of claim 1, wherein the nearest one of the plurality of servers is located at a headend.

9. The system of claim 1, wherein the connection between the plurality of servers have higher bandwidth and lower latency than the connection between a client and one of the plurality of servers.

10. A method comprising:
receiving, from a first user device, a request to participate in a communication session;
directing the first user device to a data stream comprising information related to the communication session;
receiving an interaction command from the first user device;
processing the interaction command, wherein processing the interaction command comprises rendering a communication session video according to the interaction command; and
transmitting the rendered communication session video to a plurality of servers over a network connection, wherein the plurality of servers update the communication session according to the interaction command.

11. The method of claim 10, wherein the communication session is a video game, a video conference, or a presentation.

12. The method of claim 10, wherein the interaction command is processed prior to other network traffic.

13. The method of claim 10, wherein the network connection is configured to transmit the interaction command with higher priority than other network traffic.

14. A method comprising:
receiving, at a first server, a request to participate in a communication session from a first user device;
providing the first user device a data stream comprising information related to the communication session;
receiving, at the first server, an interaction command from the first user device;
processing the interaction command, wherein processing the interaction command comprises rendering a communication session video according to the interaction command; and
transmitting, by the first server, the rendered communication session video to a second server over a network connection, wherein the first and second servers update the communication session according to the interaction command.

15. The method of claim 14, wherein the second server provides a data stream to a second user device comprising information related to the updated communication session.

16. The method of claim 14, wherein the network connection is configured to transmit the interaction command with a higher priority than other network traffic.

17. The method of claim 14, wherein the first server is the nearest server to the first user device to receive a request to participate in a communication session from the first user device.

18. The method of claim 17, wherein the first server is located at the headend of the first user device.

19. The method of claim 14, wherein processing the interaction command comprises determining the priority of the interaction command, and wherein a higher priority command is processed prior to a lower priority command.

20. The method of claim 14, wherein processing the interaction command comprises processing real-time information in the interaction command prior to non-real time information in the interaction command.
